(19) United States
(12) Patent Application Publication
(10) Pub. No.: US 2018/0036743 A1
(43) Pub. Date: Feb. 8, 2018

(54) Processes for Mineral Ore Flotation in the Presence of Multivalent Metal Ions

(71) Applicant: KEMIRA OYJ, Helsinki (FI)

(72) Inventors: Duane C. Wilson, Marietta, GA (US); Xihui Yin, Marietta, GA (US); Scott Rosencrance, Douglasville, GA (US); Anna Casasus, Alpharetta, GA (US)

(21) Appl. No.: 15/665,994

(22) Filed: Aug. 1, 2017

Related U.S. Application Data
(60) Provisional application No. 62/370,862, filed on Aug. 4, 2016.

(51) Int. Cl. B03D 1/02; B03D 1/016

(52) U.S. Cl. CPC B03D 1/02; B03D 1/016; B03D 2201/06; B03D 2201/02; B03D 2203/02

(57) ABSTRACT

Processes for enriching a desired mineral from an ore comprising the desired mineral and gangue, are provided, wherein the process comprises carrying out a flotation process in the presence of one or more chelating agents, one or more collecting agents, one or more types of multivalent metal ions, and optionally, one or more depressants, in a solution, wherein the one or more chelating agents are capable, alone or as a group of compounds, of sequestering a metal or metal ion in the form of a metal-chelating agent complex that remains at least partially soluble in the solution.

### CROSS-REFERENCE TO RELATED APPLICATIONS

This applications claims priority to U.S. Provisional Application No. 62/370,862, filed Aug. 4, 2016.

### FIELD OF THE ART

The present disclosure generally relates to chelating agents for use in mineral ore flotation processes in the presence of multivalent metal ions, in particular, under alkaline conditions.

### BACKGROUND

In the processing of mineral-containing ores, it is desirable to separate undesirable minerals known as gangue (e.g. Al₂O₃, SiO₂ and TiO₂) from the desired minerals in ore (e.g. iron ore). One method of accomplishing this goal is to depress the flotation of a particular mineral during the normal flotation process. In mineral flotation systems, it is common to depress the gangue materials while floating the desirable mineral or minerals. In differential or reverse flotation systems, it is common to depress the desired mineral or minerals while floating the gangue. Depression is conventionally accomplished by the use of one or more depressing agents (also known as depressants) during the flotation step. The depressant, when added to the flotation system, exerts a specific action on the material to be depressed thereby preventing it from floating. The ability of the depressant to facilitate such separation is referred to as its selectivity, i.e. a more selective depressant achieves better separation of the gangue from the desired minerals.

In a typical ore flotation scheme, the ore is ground to a size sufficiently small to liberate the desired mineral or minerals from the gangue. An additional step in the flotation process involves the removal of the ultra-fine particles by desliming. Ultra-fine particles are generally defined as those less than 5 to 10 microns in diameter. The desliming process may be accompanied by or followed by a flocculation step or some other type of settling step such as the use of a cyclone separating device. This step is followed by a flotation step wherein gangue materials are separated from the desired mineral or minerals in the presence of collecting agents and/or frothing agents.

Iron ore, such as hematite or magnetite, has often been upgraded by reverse flotation processes, wherein the impurities, such as quartz or silica, are floated through the use of collecting agents and frothing agents. To minimize iron loss, a depressant can be used to block collecting agent adsorption on to the iron mineral and mitigate any collecting agent that does adsorb. Multivalent metal ions, which are often present in the flotation pulp during such flotation processes, can diminish flotation performance. In particular, multivalent metal ions, such as calcium, magnesium and iron, can interact with quartz or other minerals, reducing the anionic charge and/or causing agglomeration. Therefore, the affinity for the cationic collector decreases, which can cause reduced selectivity.

### BRIEF SUMMARY

A process for enriching a desired mineral from an ore comprising the desired mineral and gangue is disclosed, wherein the process comprises carrying out a flotation process on the ore in the presence of one or more chelating agents, one or more collecting agents, one or more types of multivalent metal ions, and optionally one or more depressants, in a solution; wherein the one or more chelating agents are capable, alone or as a group of compounds, of sequestering a multivalent metal or multivalent metal ion in the form of a metal-chelating agent complex that remains at least partially soluble in the solution. In certain exemplary embodiments, the process comprises carrying out a flotation process on the ore in the presence of one or more chelating agents, one or more collecting agents, one or more types of multivalent metal ions, and one or more depressants, in a solution.

A process for the selective flotation of a desired mineral from an ore comprising the desired mineral and gangue is also disclosed, wherein the process comprises: (a) forming a flotation pulp by grinding ore comprising a desired mineral and gangue in an aqueous fluid, wherein the flotation pulp comprises one or more types of dissolved or dissolvable multivalent metal ions; (b) adding one or more chelating agents, one or more collecting agents, and optionally one or more depressants, to the flotation pulp; (c) subjecting the flotation pulp to flotation to form a flotation float product comprising the gangue and a flotation non-float product comprising the desired mineral; wherein the one or more chelating agents are capable, alone or as a group of compounds, of sequestering a multivalent metal or multivalent metal ion in the form of a metal-chelating agent complex that remains at least partially soluble in the flotation pulp. In certain exemplary embodiments, the process comprises: adding one or more chelating agents, one or more collecting agents, and one or more depressants, to the flotation pulp.

The disclosure may be understood more readily by reference to the following detailed description of the various features of the disclosure and the examples included therein.

### BRIEF DESCRIPTION OF FIGURES

FIG. 1 is plot of the resulting SiO₂ grade (%) versus Fe recovery (%) from flotation of iron ore, in the presence of calcium, treated with an exemplary depressant, an exemplary chelating agent, a combination of an exemplary depressant and exemplary chelating agent. Data for the controls is also presented.

FIG. 2 is plot of the resulting Fe grade (%) versus Fe recovery (%) from flotation of iron ore, in the presence of calcium, treated with an exemplary depressant, an exemplary chelating agent, a combination of an exemplary depressant and exemplary chelating agent. Data for the controls is also presented.

FIG. 3 is plot of the resulting SiO₂ floated (%) versus Fe recovery (%) from flotation of iron ore, in the presence of calcium, treated with an exemplary depressant, an exemplary chelating agent, a combination of an exemplary depressant and exemplary chelating agent. Data for the controls is also presented.

FIG. 4 is a bar graph depicting the relative slopes of SiO₂ grade (%) versus Fe recovery (%), Fe grade (%) versus Fe recovery (%), and SiO₂ floated (%) versus Fe recovery (%), from the flotation of iron ore, in the presence of calcium, treated with an exemplary chelating agent, or a combination of an exemplary depressant and exemplary chelating agent. Data for the blank sample and exemplary depressant baseline samples in the absence of calcium is also presented.

FIG. 5 is a graph showing the effect of the concentration of an exemplary chelating agent or starch on the SiO₂ particle size in the presence of calcium.

FIG. 6 is a graph showing the effect of pH on the SiO₂ particle size in the presence of calcium.

FIG. 7 is a plot of the resulting SiO₂ grade (%) versus Fe recovery (%) from flotation of iron ore, in the presence of calcium and at pH 10.5, treated with an exemplary depressant, an exemplary chelating agent, or a combination of an exemplary depressant and exemplary or comparative chelating agent. Data for the control is also presented.

FIG. 8 is a plot of the resulting Fe grade (%) versus Fe recovery (%) from flotation of iron ore, in the presence of calcium and at pH 10.5, treated with an exemplary depressant, an exemplary chelating agent, or a combination of an exemplary depressant and exemplary or comparative chelating agent. Data for the control is also presented.

FIG. 9 is a plot of the resulting SiO₂ floated (%) versus Fe recovery (%) from flotation of iron ore, in the presence of calcium and at pH 10.5, treated with an exemplary depressant, an exemplary chelating agent, or a combination of an exemplary depressant and exemplary or comparative chelating agent. Data for the control is also presented.

FIG. 10 is a bar graph depicting the relative slopes of SiO₂ grade (%) versus Fe recovery (%), Fe grade (%) versus Fe recovery (%), and SiO₂ floated (%) versus Fe recovery (%), from the flotation of iron ore, in the presence of calcium and at pH 10.5, treated with an exemplary depressant, an exemplary chelating agent, or a combination of an exemplary depressant and exemplary or comparative chelating agent. Data for the control is also presented.

FIG. 11 is a plot of the resulting Fe grade (%) versus Fe recovery (%) from flotation of iron ore, in the presence of calcium and at pH 7.5-8.5, treated with an exemplary depressant, an exemplary chelating agent, or a combination of an exemplary depressant and exemplary or comparative chelating agent. Data for the control is also presented.

FIG. 12 is a plot of the resulting SiO₂ grade (%) versus Fe recovery (%) from flotation of iron ore, in the presence of calcium and at pH 7.5-8.5, treated with an exemplary depressant, an exemplary chelating agent, or a combination of an exemplary depressant and exemplary or comparative chelating agent. Data for the control is also presented.

FIG. 13 is a plot of the resulting SiO₂ floated (%) versus Fe recovery (%) from flotation of iron ore, in the presence of calcium and at pH 7.5-8.5, treated with an exemplary depressant, an exemplary chelating agent, or a combination of an exemplary depressant and exemplary or comparative chelating agent. Data for the control is also presented.

FIG. 14 is a bar graph depicting the relative slopes of SiO₂ grade (%) versus Fe recovery (%), Fe grade (%) versus Fe recovery (%), and SiO₂ floated (%) versus Fe recovery (%), from the flotation of iron ore, in the presence of calcium and at pH 7.5-8.5, treated with an exemplary depressant, an exemplary chelating agent, or a combination of an exemplary depressant and exemplary or comparative chelating agent. Data for the control is also presented.

FIG. 15 is a graph showing the effect of the concentration of an exemplary or comparative chelating agent on the SiO₂ particle size in the presence of calcium.

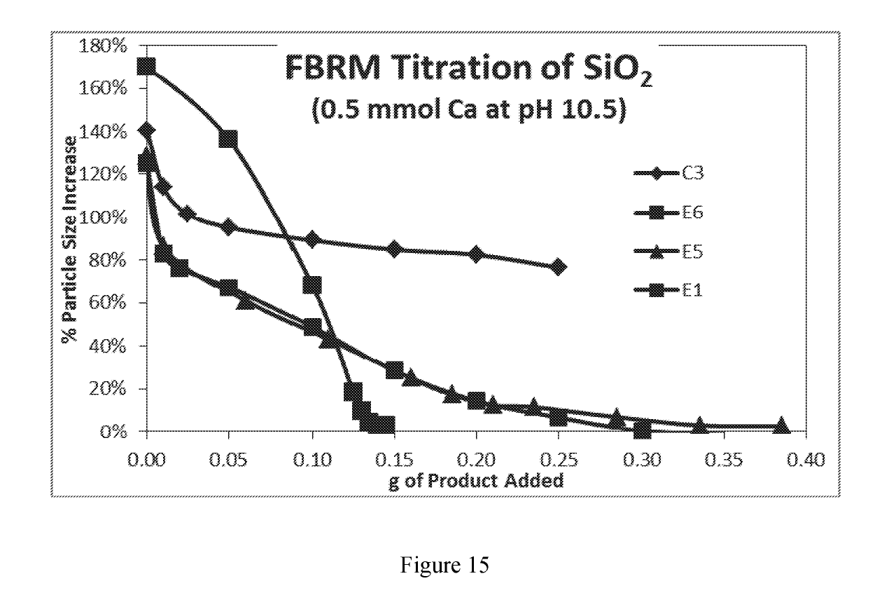

### DETAILED DESCRIPTION

According to the various exemplary embodiments described herein, the processes may be used to separate gangue from desired minerals in mineral-containing ore via flotation methods. The processes are particularly effective in the presence of multivalent metal ions, such as calcium, magnesium, or iron, which would otherwise adversely impact flotation performance. The processes include the addition of one or more chelating agents, one or more collecting agents, and optionally one or more depressants, to the flotation pulp, wherein the one or more chelating agents are capable, alone or as a group of compounds, of sequestering a multivalent metal or multivalent metal ion in the form of a metal-chelating agent complex that remains at least partially soluble in the solution or flotation pulp.

The chelating agents, collecting agents, and in certain exemplary embodiments, the depressants, as used in the exemplary processes, may provide improved selectivity. In particular, the processes may provide increased flotation process selectivity, decreased collector consumption, decreased sodium hydroxide consumption, and/or decreased landfill, as compared to other flotation processes.

In particular, it is believed in the flotation of iron ore, that multivalent metal ions such as calcium ions can adversely affect the separation of iron from the quartz, silica and silaceous materials. In reverse cationic flotation processes, which are carried out at elevated pH conditions, the collecting agent is cationic and is attracted to the negatively charged quartz. Calcium ions can interact with the quartz to diminish the negative charge of the quartz, resulting in less affinity for the cationic collecting agent. It also leads to larger particle size through agglomeration. With larger particle size, less surface area is available to interact with the collector. In reverse anionic flotation processes of iron ore, the anionic collecting agent is often a fatty acid, and both the quartz and the collector are negatively charged. Lime is commonly added to the flotation pulp as a calcium ion source to activate the quartz surface by changing the surface charge to positive. However, high concentrations of calcium—or other multivalent metal—ions can cause high consumption of anionic collecting agent.

### Definitions

As used herein, a “chelating agent” refers to coordinating ligands in which two or more sites bond to a central, multivalent metal atom, for example calcium, magnesium or iron. In certain embodiments, chelating agents are more strongly held to the metal center due to these multiple bonds, which can lead to, for example, precipitation of metal-chelating agent compounds. In certain embodiments, sequestration of the metal can also occur, for example when using a chelating agent with several bonding sites, for example EDTA, which has six bonding sites. In certain embodiments, sequestration of the metal can also occur, for example, when multiple chelating agent molecules, each only having a few binding sites, interact with the metal. In certain embodiments, sequestration of more than one metal can also occur, for example, when a single chelating agent molecule, for example, a polymeric compound, having many binding sites, interacts with many metal ions. In instances of sequestration, the metal is sufficiently complexed by the chelating agent such that no accessible bonding sites on the metal remain for other direct or indirect interactions with the minerals, collectors, or depressants in the flotation pulp. In exemplary embodiments, the metal may be sequestered in the form of a metal-chelating agent complex, which may be partially soluble, even highly soluble, in the solution. In certain embodiments, the metal-chelating agent complex is at least partially soluble in the solution. In certain embodiments, the chelating agents do not substantially form precipitates with the metal ions, for example multivalent cations, such as calcium, magnesium and iron.

As used herein, a “depressant” refers to an agent that depresses the flotation of the desired minerals in preference to depressing the flotation of the associated gangue.

As used herein, “free multivalent metal ions” refers to dissolved multivalent metal ions with accessible bonding sites, for example, those capable of interacting with the minerals, collectors, or depressants in the flotation pulp. In exemplary embodiments, the multivalent metal has an oxidation state of 2 or greater, including, for example, calcium, magnesium, or iron. In exemplary embodiments, the chelating agents can be used to facilitate the removal of free metal ions, such as calcium, magnesium or iron, from a solution or from the flotation pulp. In exemplary embodiments, the removal of free metal ions can include the sequestration of the metal ion.

As used herein, the “desired minerals” refers to minerals which have value and may be extracted from ore which contains the desired mineral and gangue. Examples of desired minerals include iron powder, hematite, magnetite, pyrite, chromite, goethite, marcasite, limonite, pyrrohotite or any other iron-containing minerals. In exemplary embodiments, the desired mineral is an iron-containing mineral, such as hematite, iron oxides or iron powder.

As used herein, “gangue” refers to the undesirable minerals in a material that contains both undesirable and desired minerals, for example an ore deposit. Such undesirable minerals may include oxides of aluminum, silica (e.g. quartz), titanium, sulfur and alkaline earth metals. In certain embodiments, the gangue includes oxides of silica, silicates or siliceous materials. In certain embodiments, the gangue comprises quartz. As used herein, “silicate gangue” refers to oxides of silica, silicates or siliceous materials, including for example quartz.

As used herein, the term “polysaccharide” refers to carbohydrate molecules of repeated monomer (monosaccharide) units joined together by glycosidic bonds. The polysaccharide may vary in structure, for example, may be linear or branched. The molecules may contain slight modifications of the repeating unit. Monosaccharides are generally aldehydes or ketones with two or more hydroxyl groups. A polysaccharide containing a single type of monosaccharide unit is referred to as a homopolysaccharide, while a polysaccharide containing more than one type of monosaccharide unit is referred to as a heteropolysaccharide. Polysaccharides are generally considered to contain ten or more monosaccharide units, while the term “oligosaccharide” is generally used to refer to the polymers containing a small number, e.g. two to ten, of monosaccharide units.

As used herein, the term “starch” refers to a carbohydrate consisting of a large number of glucose units joined by glycosidic bonds. It is well established that starch polymer consists mainly of two fractions, amylose and amylopectin, which vary with the source of starch. The amylose, having a low molecular weight, contains one end group per 200-300 anhydroglucose units. Amylopectin is of higher molecular weight and consists of more than 5,000 anhydroglucose units with one end group for every 20-30 glucose units. While amylose is a linear polymer having α 1→4 carbon linkage, amylopectin is a highly branched polymer with α 1→4 and α 1→6 carbon linkages at the branch points. In exemplary embodiments, modified starch includes, but is not limited to, dextran, oxidized starch, starch derivatives, such as carboxymethyl starch and phosphate starch; and combinations thereof.

As used herein, “ore” refers to rocks and deposits from which the desired minerals can be extracted. Other sources of the desired minerals may be included in the definition of “ore” depending on the identity of the desired mineral. The ore may contain undesirable minerals or materials, also referred to herein as gangue. In certain exemplary embodiments, the ore comprises one or more desired minerals and quartz.

As used herein, “iron ore” refers to rocks, minerals and other sources of iron from which metallic iron can be extracted. The ores are usually rich in iron oxides and vary in color from dark grey, bright yellow, deep purple, to rusty red. The iron itself is usually found in the form of magnetite (Fe₃O₄), hematite (Fe₂O₃), goethite (FeO(OH)), limonite (FeO(OH).n(H₂O)), siderite (FeCO₃) or pyrite (FeS₂). Taconite is an iron-bearing sedimentary rock in which the iron minerals are interlayered with quartz, chert, or carbonate. Itabirite, also known as banded-quartz hematite and hematite schist, is an iron and quartz formation in which the iron is present as thin layers of hematite, magnetite, or martite. Any of these types of iron are suitable for use in processes described herein. In exemplary embodiments, the iron ore is substantially magnetite, hematite, taconite or itabirite. In exemplary embodiments, the iron ore is substantially pyrite. In exemplary embodiments, the iron ore is contaminated with gangue materials, for example oxides of aluminum, silica or titanium. In exemplary embodiments, the iron ore is contaminated with clay.

As used herein, the term “flotation pulp” refers to ore dispersed in water, which is intended to undergo a flotation process to separate desired minerals from gangue. Various agents and modifiers may be added to the flotation pulp to facilitate the separation of the desired minerals from the gangue, and air is introduced into the pulp to form a froth.

Chelating Agents

In exemplary embodiments, the one or more chelating agents comprise chelating agents that are useful in mineral flotation. Exemplary chelating agents are effective in mitigating the adverse effects of multivalent metal ions on the separation of desired minerals from gangue in a flotation process. In certain embodiments, the exemplary chelating agents are used to enhance the separation of iron-containing minerals, such as hematite, iron oxides, iron powder, from quartz or silicate gangue by binding or sequestering multivalent metal ions that interact with the quartz or silicate gangue and diminish its affinity for the collector used in the flotation process. The exemplary chelating agents may be used to change the flotation characteristics of the quartz or silicate gangue, to improve the separation process, particularly in the presence of high concentrations of multivalent metal ions, such as calcium, magnesium, and iron ions.

In exemplary embodiments, the one or more chelating agents may be any compound which is capable, alone or as a group of compounds, of sequestering a multivalent metal or multivalent metal ion in the form of a metal-chelating agent complex that remains at least partially soluble in the solution. In a particular embodiment, the one or more chelating agents may be any compound which is capable, alone or as a group of compounds, of sequestering a calcium ion in the form of a metal-chelating agent complex that remains at least partially soluble in the solution.

In exemplary embodiments, the one or more chelating agents do not substantially form a metal-chelating agent complex with the multi-valent metal ion that precipitates from the solution.

In exemplary embodiments, the one or more chelating agents are selected from neutral sequestering agents or negatively charged sequestering agents in the form of a salt. In exemplary embodiments, the one or more chelating agents are selected from the group consisting of: ethylenediaminetetraacetic acid (EDTA), and salts and/or hydrates thereof, such as EDTA disodium dihydrate; citric acid, and salts and/or hydrates thereof, such as sodium citrate dihydrate or sodium citrate trihydrate; and polymers comprising one or more sulfonic acid- or carboxylic acid-containing monomers, or a salt thereof.

In exemplary embodiments, the one or more chelating agents comprise EDTA or EDTA Disodium Dihydrate. In exemplary embodiments, the one or more chelating agents comprise sodium citrate dihydrate or sodium citrate trihydrate.

In exemplary embodiments, the one or more chelating agents are selected from polymers comprising one or more sulfonic acid- or carboxylic acid-containing monomers, or a salt thereof. In exemplary embodiments, the polymers comprise about 5% to about 100%, or about 10% to about 50%, by mole of the one or more sulfonic acid- or carboxylic acid-containing monomers, with the balance comprised of other monomers. Exemplary polymers comprising one or more sulfonic acid- or carboxylic acid-containing monomers include but are not limited to acrylic acid polymers or salt thereof, such as polyacrylic acid sodium salts; homopolymers or copolymers comprising one or more monomers selected from the group consisting of acrylic acid, maleic anhydride, 2-sulfoethyl methacrylate, methacrylic acid, maleic acid, itaconic acid, 2-acrylamido-2-methylpropane sulfonic acid, sodium allyl sulfonate, 2-hydroxy ethyl acrylate, and salts thereof. The polymers may further comprise other monomers, which are not necessarily involved in chelating, such as acrylamide, allyloxyethanol, and trimethylolpropane allyl ether. In exemplary embodiments, the one or more chelating agents comprise an acrylic acid polymer or a salt thereof, for example, a sodium salt of polyacrylic acid. In exemplary embodiments, the one or more chelating agents comprise a polyacrylic acid sodium salt with a weight average molecular weight in the range of about 2000 to about 7000 kDa. In exemplary embodiments, the one or more chelating agents comprises a polyacrylic acid sodium salt with a weight average molecular weight of about 2200 kDa. In exemplary embodiments, the one or more chelating agents comprises a polyacrylic acid sodium salt with a weight average molecular weight of about 3500 kDa. In exemplary embodiments, the one or more chelating agents comprise a polyacrylic acid sodium salt with a weight average molecular weight of about 6500 kDa. In exemplary embodiments, the chelating agent is selected from polyacrylic acid; copolymers of acrylic acid and one or more monomers selected from the group consisting of maleic anhydride, 2-sulfoethyl methacrylate, methacrylic acid, acrylamide, maleic acid, itaconic acid, 2-acrylamido-2-methylpropane sulfonic acid, sodium allyl sulfonate, 2-hydroxy ethyl acrylate; and salts thereof. In certain exemplary embodiments, the copolymer of acrylic acid is a terpolymer. In exemplary embodiments, the one or more chelating agents comprise a terploymer of acrylic acid, maleic anhydride, and 2-sulfoethyl methacrylate with a weight average molecular weight of about 2300 kDa. In exemplary embodiments, the chelating agent is an acrylic acid polymer, a copolymer of acrylic acid, or a salt thereof. In exemplary embodiments, the chelating agent is an acrylic acid polymer, a copolymer of acrylic acid, or a salt thereof, and is used as a solution including about 10 to about 80%, or about 40 to about 50%, active polymer or copolymer.

In certain exemplary embodiments, the one or more chelating agents do not substantially comprise chelating agents which form metal-chelating agent complexes that precipitate from the solution or flotation pulp. In exemplary embodiments, the one or more chelating agents do not comprise sodium carbonate. In exemplary embodiments, the one or more chelating agents do not comprise sodium fluoride. In exemplary embodiments, the one or more chelating agents do not comprise sodium silicate.

According to the various exemplary embodiments, the amount of chelating agent to be used is that which will improve the flotation of the desired mineral ore or ores to a necessary or desired extent. In certain embodiments, the amount of chelating agent to be used is that which will sufficiently minimize the adverse effects of multivalent metal ions, such as calcium, magnesium, and iron ions, present during the flotation process of the desired mineral ore. The amount of chelating agent may be determined, at least in part, on a number of factors such as the desired mineral and gangue to be separated and the conditions of the flotation process, such as the amount and type of multivalent metal ions in solution. In exemplary embodiments, the amount of chelating agent used in the flotation process is about 10 to about 1000 g/mol, or about 50 to about 500 g/mol, or about 50 to about 200 g/mol of dissolved multivalent metal ions in the flotation pulp. In exemplary embodiments, the specific consumption of chelating agent in the processes is about 0.01 to about 10 kilogram, or about 0.1 to about 5 kg of chelating agent per metric ton of ore to be floated.

Collecting Agents

In exemplary embodiments, the one or more collecting agents comprise collecting agents that are useful in mineral flotation. Exemplary collecting agents may form a hydrophobic layer on a given mineral surface in the flotation pulp, which facilitates attachment of the hydrophobic particles to air bubbles and recovery of such particles in the froth product. Any collecting agent may be used in the exemplary processes. The choice of collector may be determined, at least in part, on the particular ore to be processed and on the type of gangue to be removed. Suitable collecting agents will be known to those skilled in the art. In exemplary embodiments, the collecting agents may be compounds comprising anionic groups, cationic groups or non-ionic groups. In exemplary embodiments, the collecting agents are compounds comprising cationic groups. In exemplary embodiments, the collecting agents are compounds comprising anionic groups. In exemplary embodiments, the collecting agents are compounds comprising non-ionic groups.

In certain embodiments, the collecting agents are surfactants, i.e. substances containing hydrophilic and hydrophobic groups linked together. Certain characteristics of the collecting agent may be selected to provide a selectivity and performance, including solubility, critical micelle concentration and length of carbonic chain.

Exemplary collecting agents include amines, diamines, and compounds containing oxygen and nitrogen, for example compounds with amine groups. In exemplary embodiments, the collecting agents may be selected from the group consisting of: C₁-C₂₀ amines, C₁-C₂₀ diamines, ether amines, for example primary ether monoamines, and primary ether polyamine, such as ether diamines; aliphatic C₈-C₂₀ amines for example aliphatic amines derived from various petroleum, animal and vegetable oils, octyl amine, decyl amine, dodecyl amine, tetradecyl amine, hexadecyl amine, octadecyl amine, octadecenyl amine, octadecadienyl amine, and isododecyloxypropyl-1,3-diaminopropane; quaternary amines for example dodecyl trimethyl ammonium chloride, coco trimethyl ammonium chloride, and tallow trimethyl ammonium sulfate; diamines or mixed amines for example tallow amine, hydrogenated tallow amine, coconut oil or cocoamine, soybean oil or soya-amine, tall oil amine, rosin amine, tallow diamine, coco diamine, soya diamine or tall oil diamines and the like, and quaternary ammonium compounds derived from these amines; amido amines and imidazolines such as those derived from the reaction of an amine and a fatty acid; and combinations or mixtures thereof. In exemplary embodiments, the collecting agent is an amine. In exemplary embodiments, the collecting agent is a diamine. In exemplary embodiments, the collecting agent is an ether amine. In exemplary embodiments, the collecting agent is an ether diamine. In an exemplary embodiment, the collecting agent is an ether amine or mixture of ether amines. In certain embodiments, the one or more collecting agents comprises isododecyloxypropyl-1,3-diaminopropane.

Exemplary collecting agents may be partially or wholly neutralized by a mineral or organic acid such as hydrochloric acid or acetic acid. Such neutralization facilitates dispersibility in water. In the alternative, the amine may be used as a free base amine by dissolving it in a larger volume of a suitable organic solvent such as kerosene, pine oil, alcohol, and the like before use. These solvents sometimes have undesirable effects in flotation, such as reducing flotation selectivity or producing uncontrollable frothing. Although these collecting agents differ in structure, they are similar in that they ionize in solution to give a positively charged organic ion.

According to the exemplary embodiments, the quantity of collecting agent may vary over a wide range. The amount of collecting agent may be determined, at least in part, upon the gangue content of the ore being processed. For example, ores having higher silica content may require greater quantities of collecting agents. In exemplary embodiments, about 0.01 to about 2 lbs., or about 0.1 to about 0.35 lbs., of collecting agent per ton of ore is used in the process.

Depressants

In some exemplary embodiments, the one or more depressants comprise depressants that are useful in mineral flotation. Exemplary depressants are effective in selectively depressing the flotation of desired mineral(s) as compared to gangue. In certain embodiments, the exemplary depressants are used to enhance the separation of iron-containing minerals, such as iron oxides or iron powder, from silicate gangue by differentially depressing the flotation of the iron-containing minerals relative to that of the silicate gangue. One of the challenges associated with the separation of iron-containing minerals from silicate gangue is that the iron-containing minerals and silicates both tend to float under certain processing conditions. The exemplary depressants may be used to change the flotation characteristics of the iron-containing minerals relative to silicate gangue, to improve the separation process.

In exemplary embodiments, the one or more depressants can comprise any depressant known in the art and suitable for use in a flotation process, or any conventional mineral depressant.

Exemplary depressants include, but are not limited to: polysaccharides comprising one or more types of pentosan units; cellulose esters, such as carboxymethylcellulose and sulphomethylcellulose; cellulose ethers, such as methyl cellulose, hydroxyethylcellulose and ethyl hydroxyethylcellulose; gums, such as guar gum; gum arabic, gum karaya, gum tragacanth and gum ghatti, alginates; starch; starch activated by treatment with alkali; oxidized starch; starch derivatives, such as carboxymethyl starch and phosphate starch; dextran, and combinations thereof.

In exemplary embodiments, the one or more depressants comprises at least one depressant having one or more types of polysaccharides comprising one or more types of pentosan units. Exemplary pentosan units are monosaccharides having five carbon atoms, including, for example, xylose, ribose, arabinose, and lyxose. In exemplary embodiments, the pentosan unit may be an aldopentose, which has an aldehyde functional group at position 1, such as, for example, the D- or L-forms of arabinose, ribose, xylose and lyxose. Exemplary polysaccharides include, for example, xylan, hemicellulose, and gum arabic. Exemplary hemicellulose is derived from biomass, for example grasses and wood, such as hardwood. In exemplary embodiments, the hemicellulose may contain mixtures of xylose, arabinose, mannose and galactose. Exemplary gum arabic may contain arabinose and ribose. In exemplary embodiments, the one or more types of pentosan units comprises xylan units and one or more of hemicellulose and aldopentoses. In exemplary embodiments, the one or more types of polysaccharides are derived from plant cell walls, for example sugar-cane- or corn-plant cell walls, or algae. In exemplary embodiments, the one or more types of polysaccharides are derived from sugar cane, or corn. In exemplary embodiments, the one or more types of polysaccharides are derived from sugar cane bagasse. In exemplary embodiments, the one or more types of polysaccharides are derived from corn fiber. In exemplary embodiments, the depressant may be a blend or a mixture of polysaccharides having one or more types of pentosan units. In certain embodiments, the depressant may consist essentially of polysaccharides comprising one type of pentosan unit, for example xylan. In certain embodiments, the one or more types of pentosan units comprise xylan. In exemplary embodiments, a depressant includes one or more types of polysaccharides comprising xylan units.

In exemplary embodiments, at least one of the one or more depressants comprises one or more types of polysaccharides comprising one or more types of pentosan units. In exemplary embodiments, at least one of the one or more depressants comprises one or more types of polysaccharides comprising xylan units.

In exemplary embodiments, a polysaccharide comprising xylan may be extracted from plant material or from algae with dilute alkaline solutions. In exemplary embodiments, the polysaccharide comprising xylan may be extracted from sugar cane bagasse or corn fiber with dilute alkaline solutions.

Xylan is an oligosaccharide which could be extracted in the form of 5 to 200 anhydroxylose units consisting of D-xylose units with 1β→4 linkages.

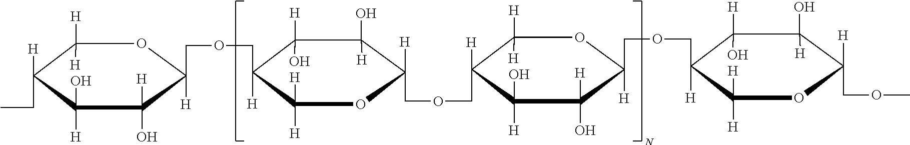

### Xylan Oligosaccharide with 5 to 200 Anhydroxylose Units Consisting of D-Xylose Units with 1β→4 Linkages

In exemplary embodiments, the polysaccharides comprising one or more types of pentosan unit may be extracted from the pulping black liquors, from the cold caustic extraction (CCE) filtrates, and/or from acid pre-hydrolysiss or auto-hydrolysis process in order to achieve dissolved pulp grades. Such extractions are described in, for example, Jayapal et al. Industrial Crops and Products 2012, v. 42, pp. 14-24; Muguet et al. Holzforschung 2011, v. 65, pp. 605-612; and Gehmayer et al. Biomacromolecules 2012, v. 13, pp. 645-651.

In exemplary embodiments, the depressants are not substantially digestible or are not suitable for human consumption. In certain embodiments, the depressants do not comprise substantial amounts of arabinose or ribose or sources thereof.

In exemplary embodiments, the depressant may have any molecular weight so long as the depressant has the effect of depressing the flotation of the desired minerals in preference to depressing the flotation of the associated gangue. In exemplary embodiments, the depressant possesses essentially no flocculating properties. In exemplary embodiments, the average molecular weight of the depressant is about 700 to about 1,000,000; about 10,000 to about 500,000; or about 50,000 to about 350,000 Daltons. In exemplary embodiments, the average molecular weight of the depressant is about 5 to about 300, about 5 to about 150, or about 5 to about 50 aldopentose units, for example xylose units.

In exemplary embodiments, the one or more depressants is present in the mineral pulp before each flotation process in a sufficient amount to prevent the iron mineral from floating. Normally, the amount of depressant is within the range from about 10 to about 2000 grams per ton ore, but this amount is not critical.

According to the various exemplary embodiments, the amount of depressant to be used is that which will depress the flotation of the desired mineral ore or ores to a necessary or desired extent. The amount of depressant needed will depend, at least in part, on a number of factors such as the desired mineral and gangue to be separated and the conditions of the flotation process. In exemplary embodiments, the amount of depressant used in the flotation process is about 0.01 to about 1.5 kilogram, or about 0.2 to about 0.7 kg of depressant per metric ton of ore to be floated. In exemplary embodiments, the specific consumption of depressant in the processes is about 0.01 to about 1.5 kilogram, or about 0.2 to about 0.7 kg of depressant per metric ton of ore to be floated.

According to the exemplary embodiments, the depressants may be used alone, or may be used in a flotation process with other depressants.

According to the various embodiments, the amount of depression may be quantified. For example, a percent of depression may be calculated by measuring the weight percent of the particular mineral or gangue floated in the absence of any depressant and measuring the weight percent of the same mineral or gangue floated in the presence of a depressant. The latter value is subtracted from the former; the difference is divided by the weight percent floated without any depressant; and this value is multiplied by 100 to obtain the percent of depression. In exemplary embodiments, the percent of depression may be any amount that will provide a necessary or desired amount of separation to enable separation of the desirable minerals from gangue. In exemplary embodiments, use of the exemplary depressant causes the flotation of desirable minerals to be depressed by at least about 5%, about 10%, or about 12%. In exemplary embodiments, use of the depressant causes the flotation of the gangue to be depressed by less than about 7.5% or about 5%.

In exemplary embodiments, the one or more depressants may each independently be provided as a composition comprising a depressant and a solvent, such as water; or in the form of a gel, for example a polysaccharide gel. In exemplary embodiments, the gel is water-soluble.

An exemplary composition may be formulated to provide a sufficient amount of depressant to a flotation process, i.e., an amount sufficient to produce a desired result.

In an exemplary embodiment, the composition may include one or more other depressants. In an exemplary embodiment, the composition may include one or more agents or modifiers. Examples of such agents or modifiers include, but are not limited to, frothers, activators, collecting agents, depressants, dispersants, acidic or basic addition agents, or any other agent known in the art.

Processes

According to exemplary embodiments, a flotation process may use the chelating agents, collecting agents, and depressants, described herein. As discussed above, flotation is a commonly used process for separating or concentrating desirable minerals from ore, for example iron from hematite. Flotation processes take advantage of the differences between the hydrophobicity of the desired minerals and that of the gangue to achieve separation of these materials. Such differences can be increased with the use of surfactants and flotation agents, including but not limited to collecting agents and depressants (also called depressing agents). Flotation processes can be adversely impacted by the presence of multivalent metal ions, such as calcium, magnesium and iron ions, especially in high concentrations, for example 240 ppm or greater. Use of the combination of the depressants and chelating agents in flotation processes according to the embodiments, can mitigate the adverse effects of multivalent metal ions, or result in other improvements, in flotation performance.

In certain exemplary embodiments, the process may be used advantageously to concentrate desirable minerals from ore comprising one or more desired minerals and quartz.

Generally, a flotation process may include the steps of grinding crushed ore, classifying the ground ore in water, treating the classified ore by flotation to concentrate one or more desired minerals in the froth while the remainder of the minerals of the ore remain in the water pulp, and collecting the minerals in the froth and/or pulp. Some of these steps are described in more detail below.

In exemplary embodiments, a flotation process comprises separating the gangue from the desirable mineral concentrate by floating the gangue in the froth and recovering the desirable mineral concentrate as the underflow. In other exemplary embodiments, a flotation process comprises separating the gangue from the desirable mineral concentrate by inducing the gangue to sink to the bottom of the cell (as underflow) and recovering the desirable mineral concentrate as the overflow (froth). In exemplary embodiments, the flotation process comprises separating iron concentrates from gangue comprising quartz, silica and other silaceous materials by flotation of the gangue and recovering the iron concentrate as underflow; i.e. a reverse flotation process.

In exemplary embodiments, a process for enriching a desired mineral from an ore comprising the desired mineral and gangue comprises carrying out a flotation process in the presence of one or more chelating agents, one or more collecting agents, one or more types of multivalent metal ions, and optionally one or more depressants; according to the embodiments described herein. In certain exemplary embodiments, the process comprises adding, or occurs in the presence of, one or more depressants. In exemplary embodiments, a process for enriching a desired mineral from an ore comprising the desired mineral and gangue comprises carrying out a flotation process in the presence of one or more chelating agents, one or more collecting agents, one or more types of multivalent metal ions, and one or more depressants; according to the embodiments described herein. In exemplary embodiments, the process is carried out in the presence of multivalent metal ions at concentration of about 1 to about 2500 ppm, about 5 to about 6000 ppm, about 5 to about 1000 ppm, about 5 to about 500 ppm, about 5 to about 375 ppm, about 5 to about 240 ppm, about 15 to about 6000 ppm, about 20 to about 800, about 15 to about 1000 ppm, about 15 to about 500 ppm, about 15 to about 375 ppm, about 15 to about 240 ppm, about 24 to about 6000 ppm, about 24 to about 1000 ppm, about 24 to about 500 ppm, about 24 to about 375 ppm, about 24 to about 240 ppm, about 38 to about 6000 ppm, about 38 to about 1000 ppm, about 38 to about 500 ppm, about 38 to about 375 ppm, about 38 to about 240 ppm, or about 240 ppm or greater.

In exemplary embodiments, a process for enriching a desired mineral from an ore comprising the desired mineral and gangue comprises carrying out a flotation process on the ore in the presence of one or more chelating agents, one or more collecting agents, one or more types of multivalent metal ions, and optionally one or more depressants, in a solution; wherein the one or more chelating agents are capable, alone or as a group of compounds, of sequestering a metal or metal ion in the form of a metal-chelating agent complex that remains at least partially soluble in the solution.

In exemplary embodiments, a process for the selective flotation of a desired mineral from an ore comprising the desired mineral and gangue comprises: (a) forming a flotation pulp by grinding ore comprising a desired mineral and gangue in an aqueous fluid, wherein the flotation pulp comprises one or more types of multivalent metal ions; (b) adding one or more chelating agents, one or more collecting agents, and optionally one or more depressants, to the flotation pulp; (c) subjecting the flotation pulp to flotation to form a flotation float product comprising the gangue and a flotation non-float product comprising the desired mineral; wherein the one or more chelating agents are capable, alone or as a group of compounds, of sequestering a metal or metal ion in the form of a metal-chelating agent complex that remains at least partially soluble in the flotation pulp.

In exemplary embodiments, a process for the selective flotation of a desired mineral from an ore comprising the desired mineral and gangue comprises: (a) forming a flotation pulp by grinding ore comprising a desired mineral and gangue in an aqueous fluid, wherein the flotation pulp comprises one or more types of multivalent metal ions; (b) adding one or more depressants, one or more chelating agents and one or more collecting agents to the flotation pulp; (c) subjecting the flotation pulp to flotation to form a flotation float product comprising the gangue and a flotation non-float product comprising the desired mineral.

In some exemplary embodiments, the process further comprises step (d) separating the flotation float product from the flotation non-float product.

In exemplary embodiments, a process for enriching a desired mineral from an ore having the desired mineral and gangue includes carrying out a flotation process in the presence of one or more depressants, one or more chelating agents and one or more collecting agents, according to the embodiments described herein. In exemplary embodiments, the process is carried out in the presence of multivalent metal ions, including high concentrations (e.g. 240 ppm or greater) of multivalent metal ions.

In exemplary embodiments, a process for enriching an iron-containing mineral from an ore having the iron-containing material and quartz- and/or silicate-containing gangue, includes carrying out a flotation process in the presence of one or more depressants, one or more chelating agents and one or more collecting agents, according to the embodiments described herein.

In exemplary embodiments, the flotation process is a reverse or inverted flotation process. In exemplary embodiments, the flotation process is a reverse cationic flotation process, wherein the flotation of the desired mineral is selectively depressed when compared to the flotation of the gangue so as to facilitate separation and recovery of the desired mineral and the one or more collecting agents used are cationic. In exemplary embodiments, the flotation process is a reverse anionic flotation process, wherein the flotation of the desired mineral is selectively depressed when compared to the flotation of the gangue so as to facilitate separation and recovery of the desired mineral and the one or more collecting agents used are anionic. In exemplary embodiments, the flotation process is a direct flotation process, for example a cationic or anionic flotation process.

In exemplary embodiments, the one or more depressants may be added at any stage of the process prior to the flotation step. In exemplary embodiments, the one or more chelating agents may be added at any stage of the process prior to the flotation step. In certain embodiments, the one or more depressants are added before or with the addition of the chelating agents. In certain embodiments, the one or more chelating agents are added before the one or more depressants. In certain embodiments, the one or more chelating agents are added simultaneously with, or substantially at the same time as, the one or more depressants. In certain embodiments, the one or more chelating agents are added after the one or more depressants.

In an exemplary process, various agents and modifiers may be added to the ore that is dispersed in water (flotation pulp), and air is introduced into the pulp to form a froth. The resulting froth contains those materials which are not wetted and have an affinity for air bubbles. Examples of such agents and modifiers include but are not limited to collecting agents, depressants, chelating agents, frothers, activators, dispersants, acidic or basic addition agents, or any other agent known in the art.

In exemplary embodiments, a collecting agent or collector may be added to the flotation pulp. In exemplary embodiments, one type of collecting agent is used in the process. In exemplary embodiments, two or more collecting agents are used in the process.

In exemplary embodiments, one or more frothing agents are used in the process. Exemplary frothing agents are heteropolar organic compounds which reduce surface tension by being absorbed at air-water interfaces and thus facilitate formation of bubbles and froth. Examples of frothing agents are methylisobutyl carbinol; alcohols having 6-12 carbon atoms which optionally are alkoxylated with ethylene oxide and/or propylene oxide; pine oil; cresylic acid; various alcohols and soaps. In exemplary embodiments, about 0.001 to 0.2 lb. of frothing agent per ton of ore are provided.

According to an exemplary embodiment, after completion of the flotation, a gangue-enriched flotate (froth), for example a silicate-enriched flotate, and a bottom fraction rich in the desired mineral (tailings, underflow), for example iron, are produced.

According to the embodiments, one or more steps may be done prior to the flotation step to prepare the ore for flotation. For example, in one step of the process, the ore can be ground, together with water, to the desired particle size, for example a particle size between about 5 and about 200 μm. Optionally, conditioning agents such as sodium hydroxide may be added to the grinding mill prior to grinding the crude ore. In exemplary embodiments, sufficient water is added to the grinding mill to provide a slurry containing approximately 70% solids. In certain embodiments, the process does not comprise the addition of sodium silicate.

In exemplary processes, the ground ore may be deslimed. For example, the ground ore may be suspended in water, and fine material maybe deslimed, for instance, by filtration, settling, siphoning or centrifuging. In exemplary embodiments, the desliming step may be repeated one or more times.

In exemplary processes, an ore-water slurry may be prepared from the deslimed ore, and one or more depressants and one or more chelating agents according to the embodiments may be added to the slurry. In exemplary embodiments, the one or more depressants are added in an amount of about 10 to about 1500 g per ton of ore. In exemplary embodiments, the one or more chelating agents are added in an amount of about 10 to about 15000 g per ton of ore. In exemplary embodiments, the ore-water slurry is transferred to a flotation cell and the one or more depressants and one or more chelating agents according to the embodiments are added to the ore water slurry in the flotation cell.

In exemplary embodiments, base or alkali may be added to adjust the pH of the slurry. For example, the slurry may be adjusted to a pH in the range of about 9 to about 13, about 9.5 to about 12, about 10 to about 11, or about 10.4 to about 10.6. In certain embodiments, the pH is adjusted to about 10.5. In exemplary embodiments, the pH of the slurry in the flotation cell is maintained at between about 9 and about 13, or about 9.5 to about 12.

In exemplary embodiments, the flotation process is carried out at a pH in the range of about 9 to about 13, about 9.5 to about 12, about 10 to about 11, or about 10.4 to about 10.6.

In exemplary embodiments, the pH of the flotation pulp is adjusted to a pH in the range of about 9 to about 13, about 9.5 to about 12, about 10 to about 11, or about 10.4 to about 10.6.

According to the embodiments, in one step of the flotation process, one or more collecting agents may be added, for example after the addition of the one or more depressants, one or more chelating agents and any other process agents.

In exemplary embodiments, once all of the processing agents have been added, the mixture is further conditioned or agitated for a period of time before the froth flotation is carried out. If desired, a froth-regulating means can be added on a convenient occasion before the froth flotation.

In exemplary embodiments, the flotation process may be performed in a plurality of flotation processing steps. For example, the flotation process may be performed in flotation units containing a plurality of communicating cells in series, with the first cell(s) being used generally for the rougher flotation, and subsequent cell(s) being used for the cleaner flotation. In exemplary embodiments, each flotation cell may include any flotation equipment, including, for example, the Denver laboratory flotation machine and/or the Wemco Fagergren laboratory flotation machine, in which the slurry mixture is agitated and air is injected near the bottom of the cell as desired.

In exemplary embodiments, before flotation treatment the ore-water slurry comprises about 20 to about 40% by weight solids. The duration of the flotation process depends upon the desired result. In exemplary embodiments, the time of flotation treatment may be from about 1 to 10 minutes for each circuit. The time of the flotation process may be determined, at least in part, upon the gangue content, the grain size of the ore being treated and the number of flotation cells involved.

According to the embodiments, in the rougher flotation treatment, the gangue may be selectively separated from the ore and removed with the flotation froth. The desired mineral concentrate from the flotation treatment is removed as the underflow and isolated as the rougher concentrate. In exemplary embodiments, the concentrate of the desirable mineral in the rougher concentrate is found to contain a sufficiently low quantity of gangue to be suitable for almost any desired use.

In exemplary embodiments, the flotation froth, the rougher concentrate, or both may be further processed. For example, the overflow or froth from the rougher flotation may be advanced to a first cleaner flotation cell where a second flotation treatment is performed. The underflow from this first cleaning flotation cell is an mineral concentrate identified as the first cleaner middlings which generally will contain more gangue than the rougher concentrate but significantly less gangue than the original crude ore. The overflow frothing from the first cleaning cell may be advanced to a second cleaning flotation cell where the flotation procedure is repeated and another mineral concentrate is obtained which is identified as the second cleaner middlings. In exemplary embodiments, the froth flotation cleaning is repeated one or more times. Any or all of the cleaner middlings may be combined with a rougher concentrate to provide an upgraded mineral ore concentrate. The extent to which the rougher concentrate is combined with the various middling fractions may be determined, for example, by the desired mineral content of the final product derived from the procedure. As an alternative embodiment, the cleaner middlings may be returned and recycled through the rougher flotation cell to further upgrade these cleaner middlings.

The processes of the exemplary embodiments can be used to provide higher selectivity and desired mineral recoveries, particularly in the presence of multivalent metal ions, as compared to other flotation processes which do not employ the exemplary combinations of depressants and/or chelating agents. In exemplary embodiments, the mineral concentrate, e.g. hematite concentrate, that is obtained by the exemplary processes meets the specifications for the steel industry. In exemplary embodiments, the depressants, compositions and processes can be used to maximize the iron recovery to increase production of metallic charge per unit ore fed, which may provide increases in production and profitability.

The following examples are presented for illustrative purposes only, and are not intended to be limiting.

### EXAMPLES

### Chelating Agents in the Examples

Data for flotation tests and particle size analyses in the presence of several exemplary and comparative chelating agents is presented herein. Table 1 provides a key to the exemplary chelating agents and comparative compounds, and their corresponding labels, which are used throughout the Examples. Exemplary chelating agents are indicated with an “E” before the label number. Compounds indicated with a “C” before the label number are comparative.

TABLE 1
Chelating Agents and Comparative Compounds

| Label | Compound |
|---|---|
| E1 | EDTA Disodium Dihydrate |
| E2 | Sodium Citrate Trihydrate |
| E3* | Acrylic Acid, Maleic Anhydride, and 2-Sulfoethyl Methacrylate |
| | Terpolymer (M_{w} ~2300 kDa)) |
| E4* | Polyacrylic Acid Sodium Salt (M_{w} ~2200 kDa) |
| E5* | Polyacrylic Acid Sodium Salt (M_{w} ~3500 kDa) |
| E6* | Polyacrylic Acid Sodium Salt (M_{w} ~6500 kDa) |
| C1 | Na₂CO₃ |
| C2 | Starch (pearl corn starch) |
| C3 | Sodium Silicate-Polyacrylate blend |

*Aqueous polymer solutions have a concentration of 40-50% actives.

### Example 1. Flotation Tests with an Exemplary Depressant and an Exemplary Chelating Agent in the Presence of Calcium

The exemplary depressant, depressant X, used in these experiments was a blend of polysaccharides present in plant cell walls comprising mainly xylan. Depressant X can be prepared, for example, by extracting corn fiber in deionized water containing NaOH and H₂O₂ at about 70-80° C. for 2-16 h. Solids can be removed by centrifugation and the depressant X solution can be stored in a refrigerator until use.

The exemplary chelating agent used in these experiments was E1.

Flotation tests described herein were performed with iron ore pulp samples having 30% solids (for example, 387 g ore) in a 1-L Metso laboratory flotation cell with continuous agitation at 800 rpm and according to the following procedure. Calcium hydroxide (0.367 g) was first added to the pulp sample. The exemplary depressant was then added to the pulp sample (for example, 77.4 g, or 2 kg of depressant X per ton of ore as a 1% solution), as specified in Table 2, below. In samples where no depressant was added, deionized water (77.4 g) was added in place of the depressant. The exemplary E1 chelating agent (3.97 g), was added to certain samples, as specified in Table 2, below. Subsequently, the pH was adjusted to 10.5 with 25% NaOH (aq), and the mixture was conditioned for 5 minutes. The collector (for example, 220 g of Isododecyloxypropyl-1,3-diaminopropane/MT ore solids) was added and the mixture with the collector was conditioned for 1 minute. The frother (for example, 50 g MIBC/ton ore solids) was added simultaneously upon initiation of airflow. Four froth fractions (tails) were collected from times 0 to 30 s; 30 to 60 s; 60 to 120 s; and 120 to 180 s. Air flow was stopped after 180 s. The concentrate and four tailing samples were oven dried, weighed, collected, and analyzed for Fe and Si by X-ray fluorescence (XRF).

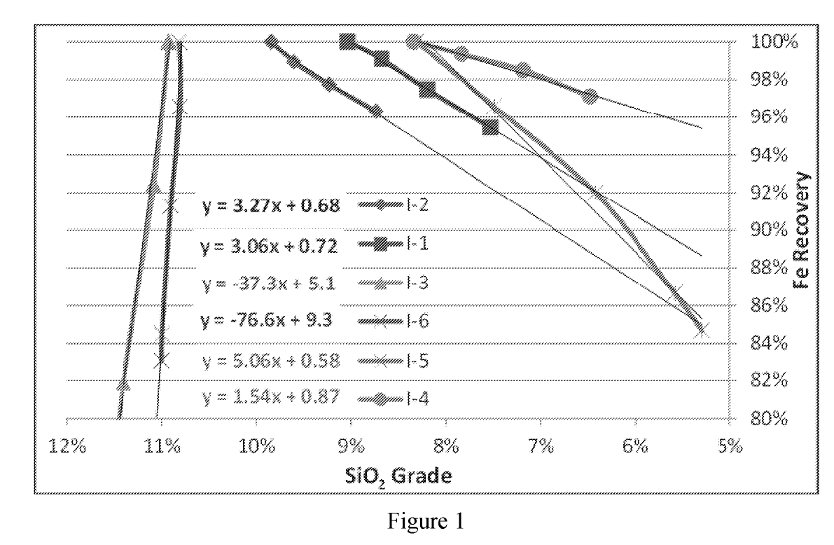

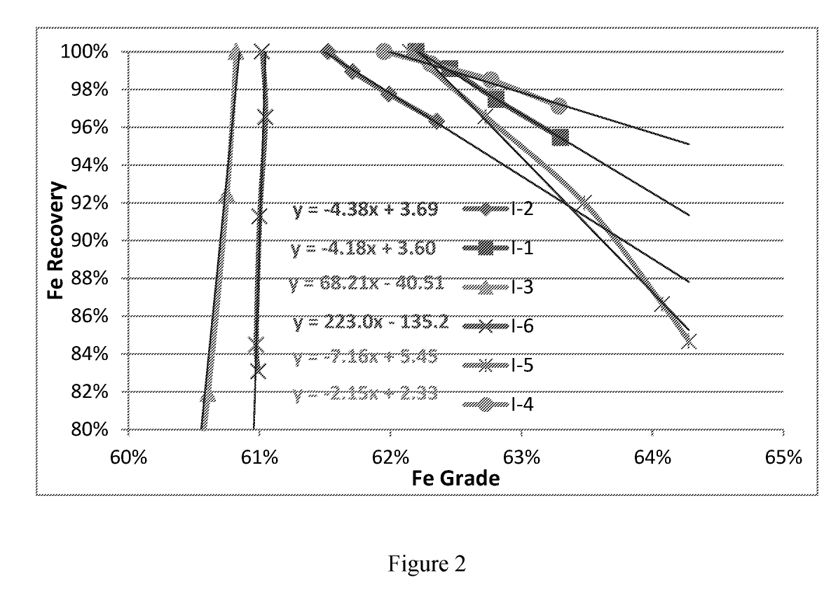

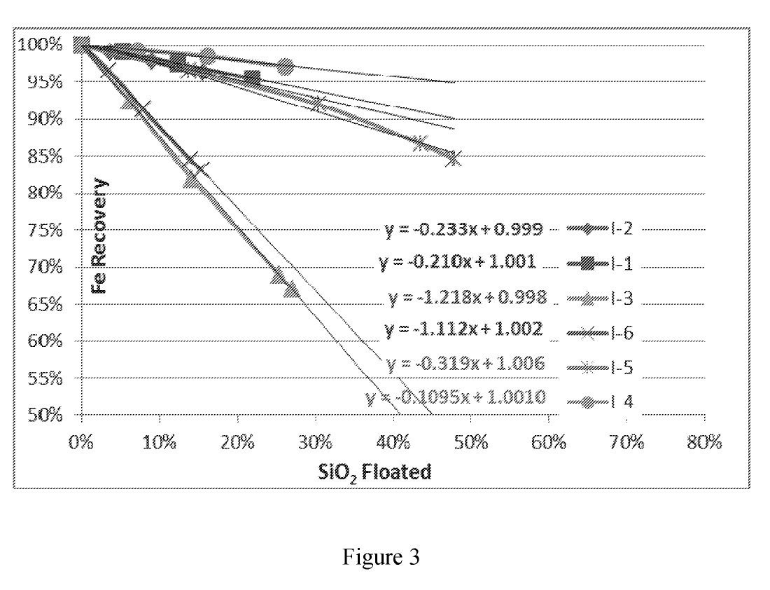

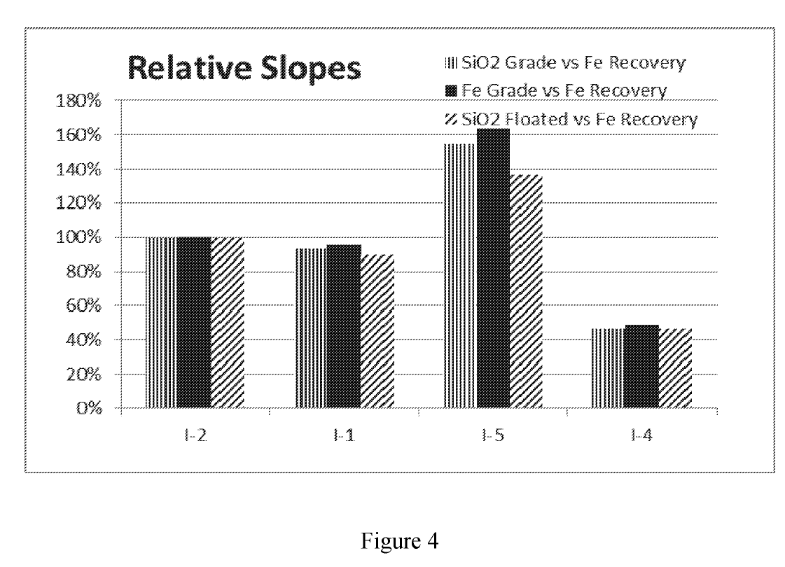

The flotation reaction conditions and results are shown in Table 2 and in FIGS. 1-4. Initial feed concentrations were calculated based on sum of all tail and concentrate analyses. The XRF data was used to calculate and plot silica grade versus Fe recovery and Fe grade versus Fe recovery (FIGS. 1, 2 and 3). The relative slopes are presented in FIG. 4.

Efficacy can be evaluated by visual inspection of the plot of % Fe Recovery versus % Fe Grade. Iron recovery (% Fe Recovery) is the percent by mass of Fe in the concentrate from the total Fe in the feed. The % Fe Grade is the concentration by mass of the Fe in the total mass of a sample.

Since silica removal is the objective, % Fe Recovery versus % SiO₂ Grade is also considered.

Position of the series cannot be directly compared since the feed grades (where recovery=100%) differ. These series are typically curves and require polynomial fits. However, under conditions targeted in this report, typical curves were not observed and linear fits were used. The slope of the linear regression was used as a numeric approximation of efficacy. The relative slope for a given series is its slope divided by the slope of the blank, expressed as a percent. As slopes or relative slopes approach zero, the change (or loss) in Fe recovery decreases, while the grade improvement increases. Therefore, slopes or relative slopes closer to zero have higher efficacy or performance. Relative slopes are plotted in bar charts for easy comparison, where values closest to zero indicate the highest efficacy.

TABLE 2
Flotation Reaction Conditions and Results

| | | | Chelating | | | | | | |
|---|---|---|---|---|---|---|---|---|---|
| | | | Agent | | | | | | |
| | | Depressant | E1 | Ca | | Slope | | Relative Slope | |
| Sample | Description | X (g/ton) | (g/ton) | (ppm) | pH | SiO₂ | Fe | SiO₂ | Fe |
| I-1 | X (low Ca | 2000 | 0 | 38 | 10.52 | 3.06 | −4.18 | 93.6% | 95.4% |
| | baseline) | | | | | | | | |
| I-2 | None (low | 0 | 0 | 38 | 10.55 | 3.27 | −4.38 | 100% | 100% |
| | Ca Blank) | | | | | | | | |
| I-3 | None (high | 0 | 0 | 240 | 10.53 | −37.3 | 68.2 | −1140% | −1560% |
| | Ca Blank) | | | | | | | | |
| I-4 | X + E1 | 2000 | 10200 | 240 | 10.53 | 1.54 | −2.15 | 47.1% | 49.1% |
| I-5 | E1 | 0 | 10200 | 240 | 10.49 | 5.06 | −7.16 | 158% | 163% |
| I-6 | X | 2000 | 0 | 240 | 10.51 | −76.6 | 223 | −2340% | −5090% |

Generally, it was observed that low levels of Ca (38 ppm) resulted in good selectivity, while high levels of free Ca (240 ppm) resulted in no or reversed selectivity. High levels of Ca (240 ppm) sequestered by exemplary chelating agent) resulted in good selectivity. The best selectivity was observed when Ca was sequestered by E1 and an exemplary depressant was used, indicating a synergistic effect between the chelating agent and depressant.

### Example 2. Qualitative Particle Size Analysis

Particle Size experiments were performed on 300 g slurries with 5% solids in deionized water. Slurries were prepared by adding water (285 g, deionized) to a single mineral (15 g of quartz or hematite) or a mixture of minerals (13.5 g hematite and 0.15 g quartz) with stirring for at least 30 min in a covered beaker at room temperature. Pure hematite and quartz were obtained from Sigma-Aldrich as iron(III) oxide powder, <5 μm, ≧99%, BET Surface Area: 5.74 m²/g; and silicon dioxide, about 99%, 0.5-10 μm (approximately 80% between 1-5 μm), BET Surface Area: 5.82 m²/g.

Qualitative particle size experiments were carried out to assess the impact of calcium, an exemplary depressant and an exemplary chelating agent on quartz agglomeration. The results are shown in Tables 3 and 4.

TABLE 3
Qualitative Particle Size Analysis

| Slurry Solids | | | First Reagent | | |
|---|---|---|---|---|---|
| Fe₂O₃ | SiO₂ | Ca(OH)₂ (g) | X (mL) | E1 (mL) | Result |
| 4.5% | 0.5% | — | — | — | NE |
| 4.5% | 0.5% | 0.030 | — | — | Agl. |
| 4.5% | 0.5% | 0.030 | 0.493 | 2.5 | Dis. |
| 4.5% | 0.5% | 0.030 | — | 2.5 | Dis. |

NE = Negligible Effect;
Agl. = Agglomeration;
Dis. = Dispersion

TABLE 4
Qualitative Particle Size Analysis

| Slurry Solids | | | | | | | |
|---|---|---|---|---|---|---|---|
| Fe₂O₃ | SiO₂ | First Reagent | | Second Reagent | | Third Reagent | |
| 5.0% | — | Ca(OH)₂ | NE | X | NE | — | — |
| 5.0% | — | E1 | NE | Ca(OH)₂ | NE | — | — |
| 5.0% | — | X | NE | Ca(OH)₂ | NE | — | — |
| — | 5.0% | Ca(OH)₂ | Agl. | X | Sl. Dis. | E1 | Full Dis. |
| — | 5.0% | E1 | NE | Ca(OH)₂ | NE | X | NE |
| — | 5.0% | X | NE | Ca(OH)₂ | Agl. | E1 | Dis. |
| — | 5.0% | X | NE | E1 | NE | Ca(OH)₂ | NE |

Sl. = Slight; NE = Negligible Effect; Agl. = Agglomeration; Dis. = Dispersion

Qualitative particle size analysis results indicated that the calcium caused quartz agglomeration and no change for hematite. Chelating agent E1 reversed or prevented this agglomeration.

### Example 3. Particle Size Analysis with Various Chelating Agents

In this example, the agglomeration of quartz which occurred in the presence of calcium, as described in Example 2, was exploited to compare chelating agents.

Particle Size experiments were performed on 300 g slurries with 5% solids in deionized water. Pure hematite and quartz were obtained from Sigma-Aldrich as iron(III) oxide powder, <5 μm, ≧99%, BET Surface Area: 5.74 m²/g; and silicon dioxide, about 99%, 0.5-10 μm (approximately 80% between 1-5 μm), BET Surface Area: 5.82 m²/g.

Titrations were performed on the slurries (300 g) with stirring (400 rpm) and tight control of pH at 10.50±0.02 by NaOH (1.0 M and 0.10 M) and HCl (1.2M and 0.12M) addition. Titrations were monitored by Focused Beam Reflective Measurements (FBRM) particle size analysis. The initial particle size was recorded and CaCl₂ (5 mL, 0.100 M Ca, 0.500 mmol Ca) was added. The agglomeration of SiO₂ was measured by change in mean particle size. Aliquots of titrant solution (ca. 0.1 to 5 mL) were added to bring the mean particle size of SiO₂ back to the initial mean particle size values.

The CaCl₂ (0.100 M) solution was prepared by dissolving CaCl₂.2H₂O (1.4701 g) in a 100 mL volumetric flask with deionized water (calculated: 4.008 mg Ca/L; ICP analysis: 4.004 mg Ca/L). Titrant solutions were prepared by dissolving 2.50 g of titrant in 50 mL volumetric flasks. Titrants analyzed included: E1 (372.24 g/mol), E2 (294.1 g/mol), E3, E4, E6, and C1 (105.99 g/mol), and C2 (Sigma-Aldrich). For E1 and C2, the minimum amount of NaOH (1.0M, about 10 mL) was used to aid in dissolution. C2 was prepared at a lower concentration of 1.00 g of starch in a 50 mL volumetric flask. The starch solution was used within 4 h of preparation.

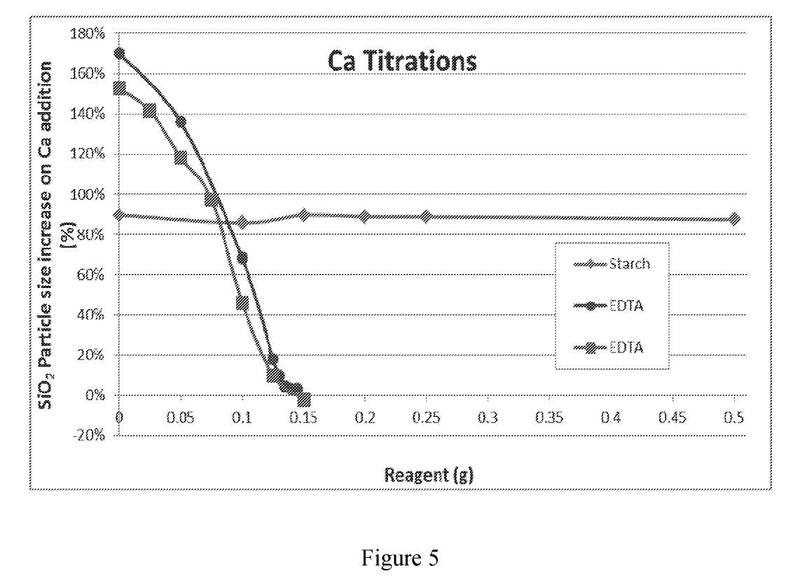

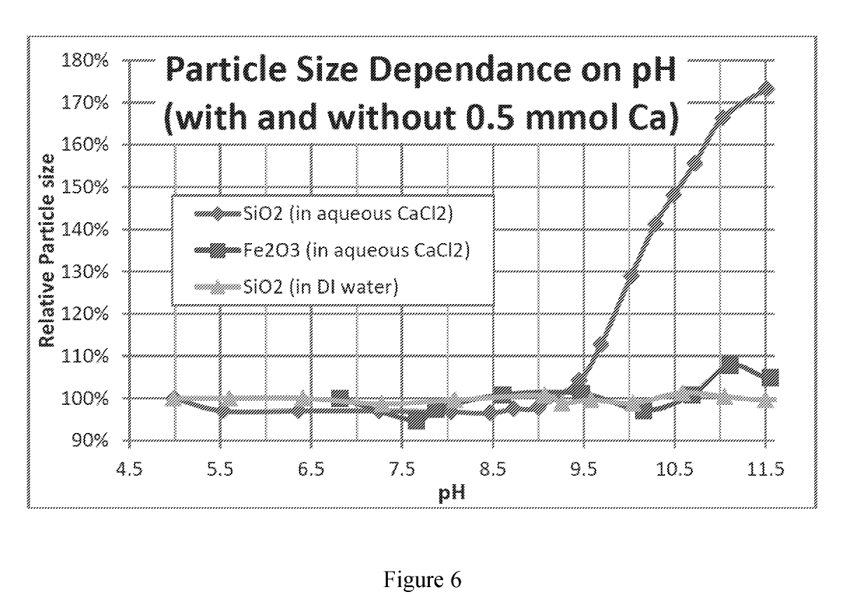

Less than one equivalent of E1 or E2 was needed to reverse the agglomeration effect caused by calcium. E3, E4 and E6 were also very effective requiring about 244, 240, and 252 g of dry product per mole of calcium ion, respectively. C2, however, showed no impact on quartz particle size. Titration curves for E1 and C2 samples are shown in FIG. 5. The pH dependence of Ca-induced agglomeration of quartz (see FIG. 6) indicates this effect is more pronounced at higher pH, but may be significant down to a pH of 7.

### Materials and Methods for Examples 4 and 5

Iron ore slurries were obtained from a source in Grand Rapids, Minn. The process water was decanted off and the solids were oven dried. The dry solid agglomerates were gently broken by hand to pass a 20-mesh sieve, and repeatedly split in half with a riffle splitter to generate manageable lot sizes of about 1.8 kg, which were thoroughly blended by tumbling in a 1 L bottle. The process water was used to reconstitute the slurry. Tomamine DA-16 (a synthetic ether diamine collector) and MIBC (Methyl Isobutyl Carbinol, frother) were diluted with deionized water to 1% aqueous solutions prior to use. Most reagents were obtained from Fisher Scientific.

The exemplary depressant, depressant X, used in these experiments was a blend of polysaccharides present in plant cell walls comprising mainly xylan, which can be prepared as described above in Example 1.

### Example 4. Flotation Tests with Exemplary Chelating Agents and Comparative Compounds in the Presence of Calcium

In this example, flotation tests were performed for seven samples (A-G) in a 1-liter Metso laboratory flotation cell with continuous agitation at 800 rpm. For each flotation test, a 60% solid slurry was generated by mixing ore (308 g) and process water (205 g) in the flotation cell. The pH was adjusted to, and maintained at, 10.5 with NaOH (25%) solution. Depressant X was premixed with the specified amount of chelating agent or comparative compound (see Table 6) and brought to a total solution weight of 30.8 g with the addition of DI water for (1% depressant solution, 1000 g dry depressant/ton ore solids). The premixed solution of depressant and chelating agent/comparative compound was added to the slurry and the mixture was conditioned for 5 minutes while maintaining a pH of 10.5 with NaOH. The solids were adjusted to 25% by adding additional process water (680 g). The collector (6.78 g, 1% solution, 220 g Tomamine DA-16/MT ore solids) and frother (1.54 mL, 1% solution, 50 g MIBC/ton ore solids) were added and the resultant mixture was conditioned for 1 minute while maintaining a pH of 10.5. Air flow (generated by agitator set to 800 rpm) was then initiated to begin flotation. The pH measured prior to flotation was about 10.5. Four froth (tail) fractions were collected from times: 0 to 30 s; 30 to 60 s; 60 to 90 s; and 90 to 180 s. Air flow was stopped after 180 s. The four tailing samples and concentrate sample were dried, weighed, collected, and analyzed for Fe and Si by X-ray fluorescence (XRF). Initial feed concentrations were calculated based on the sum of all tail and concentrate analyses.

Efficacy can be evaluated by visual inspection of the plot of % Fe Recovery versus % Fe Grade. Iron recovery (% Fe Recovery) is the percent by mass of Fe in the concentrate from the total Fe in the feed. The % Fe Grade is the concentration by mass of the Fe in the total mass of a sample.

Since silica removal is the objective, % Fe Recovery versus % SiO₂ Grade is also considered.

Position of the series cannot be directly compared since the feed grades (where recovery=100%) differ. These series are typically curves and require polynomial fits. However, under conditions targeted in this report, typical curves were not observed and linear fits were used. The slope of the linear regression was used as a numeric approximation of efficacy. The relative slope for a given series is its slope divided by the slope of the blank, expressed as a percent. As slopes or relative slopes approach zero, the change (or loss) in Fe recovery decreases, while the grade improvement increases. Therefore, slopes or relative slopes closer to zero have higher efficacy or performance. Relative slopes are plotted in bar charts for easy comparison, where values closest to zero indicate the highest efficacy.

The selectivity index (SI) is calculated as shown in Equation 1, where % grades are used for each term. SI can be a quick gauge of flotation efficacy. However, it only incorporates % grade and a more thorough analysis should include both grade and recovery data.

$$Selectivity Index = \sqrt{\frac{{Fe}_{conc} \times {SiO}_{2 tail}}{{Fe}_{tail} \times {SiO}_{2 conc}}}$$

Depression of each mineral is another way to gauge performance. Expressed as a percent, depression is calculated as shown Equation 2, where b is the mineral's weight percent floated without depressant (Blank) and d is the mineral's weight percent floated with the depressant. For reverse flotation of iron ore, high depression values for Fe₂O₃ and zero or negative depression values for SiO₂ indicate a good, selective depressant.

$$Depression = \frac{b - d}{b}$$

Results and Discussion

The analysis of the process water used in these experiments is shown in Table 5.

TABLE 5
Ion Analysis of Process Water

| Ions | ppm |
|---|---|
| Br | 205 |
| Cl | 62 |
| Ca | 38 |
| Mg | 24 |
| Na | 8 |
| F | 7 |
| K | 2 |
| Fe | <1 |

The multivalent metal ions Ca, Mg, and Fe are those which are targeted for sequestration. As indicated by titrations, E6 required 252 g of dry product per mole of Ca (or total moles of multivalent metal ions). Therefore, the calculated loading of E6 for this sample of process water at 25% solids is 3,252 g of E6/ton of ore.

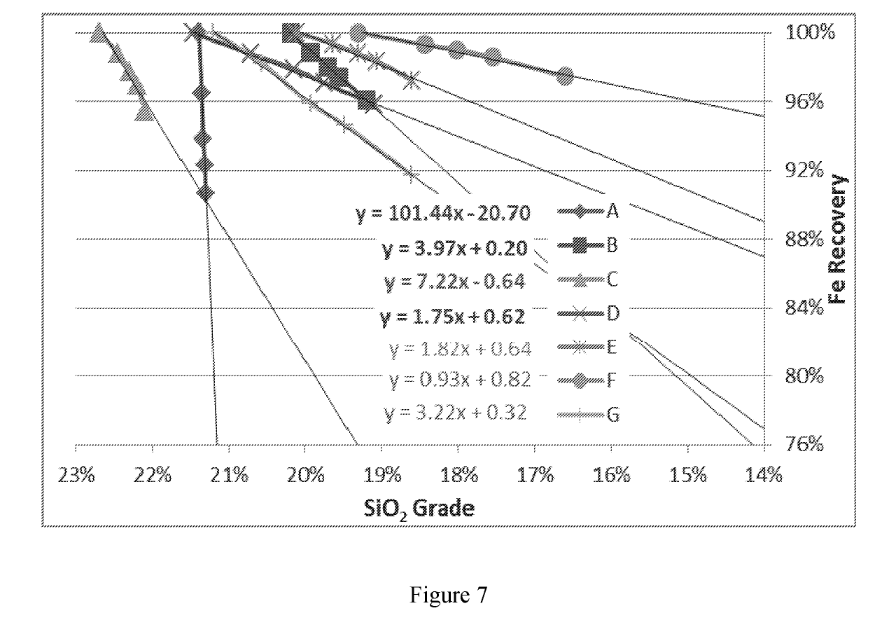

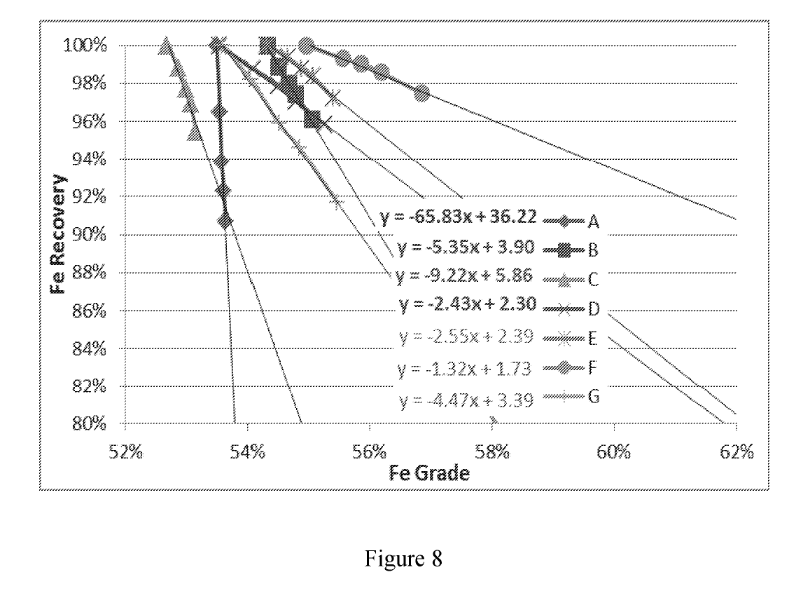

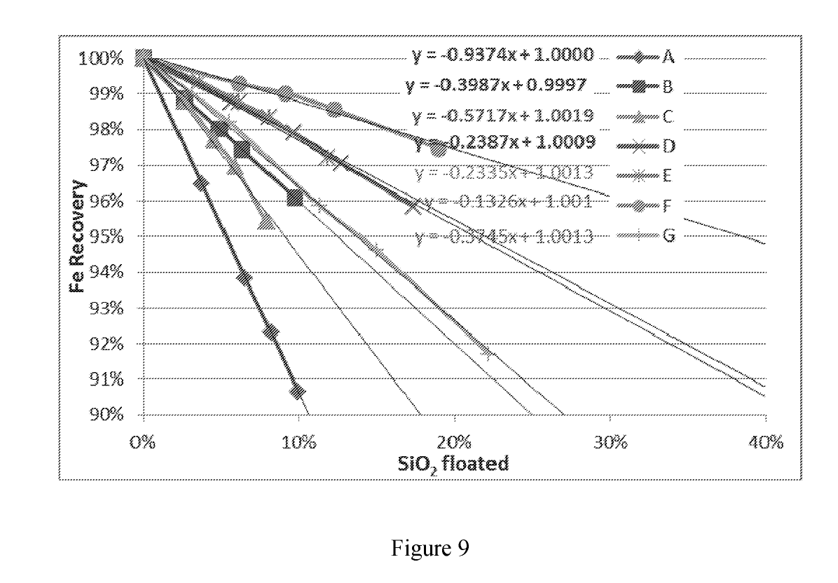

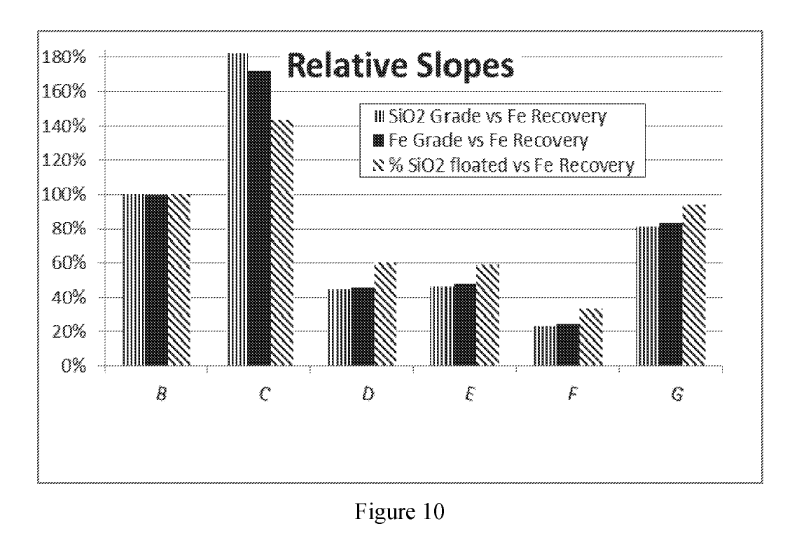

The results of flotations at pH 10.5 are presented in Table 6 and FIGS. 7-10.

TABLE 6
Flotation conditions and results for experiments A-G.

| | | Chelating. | | | | | | | | | |
|---|---|---|---|---|---|---|---|---|---|---|---|
| | | Agent/Comp. | | | | % | | | | | |
| | Depressant | Cpd. | | | Fe | Depression | | | Relative slope | | |
| ID | X (g/ton) | Type | (g/ton) | pH | Recovery | Fe₂O₃ | SiO₂ | SI | SiO₂ ^{a} | Fe ^{a} | SiO₂ ^{b} |
| A | — | — | — | 10.51 | 90.7% | 0.00% | 0.00% | 1.04 | 2,555% | 1,230% | 235% |
| B | 1,000 | — | — | 10.53 | 96.1% | 58.0% | 1.66% | 1.63 | 100% | 100% | 100% |
| C | 1,000 | C3 | 3,252 | 10.54 | 95.4% | 50.9% | 20.5% | 1.34 | 182% | 172% | 143% |
| D | 1,000 | E6 | 3,252 | 10.51 | 95.8% | 55.5% | −74.3% | 2.20 | 44.1% | 45.4% | 59.9% |
| E | 1,000 | E5 | 325 | 10.56 | 97.2% | 70.1% | −19.2% | 2.17 | 45.8% | 47.7% | 58.6% |
| F | 1,000 | E5 | 3,252 | 10.53 | 97.5% | 72.8% | −90.9% | 3.00 | 23.4% | 24.7% | 33.3% |
| G | — | E5 | 3,252 | 10.55 | 91.7% | 11.2% | −123% | 1.78 | 81.1% | 83.6% | 93.9% |

^{a} % Grade vs % Fe Recovery;
^{b} % Floated vs % Fe Recovery.

Experiment A (blank) showed very little selectivity. When depressant X is used, as in Experiment B (baseline), selectivity is significantly improved. In Experiment C, Comparative Compound C3 resulted in decreased selectivity from B (baseline). E6 and E5 improved selectivity. Experiment D shows that E6 facilitates an increase in SiO₂ flotation (negative depression) while not significantly affecting the Fe₂O₃ depression (versus B). When comparing depression values of experiments B, F, and G, it appears that E5 increases SiO₂ flotation and increases Fe₂O₃ depression, which leads to superior performance. Significant improvements in flotation selectivity are observed from the baseline (B), with only 325 g/ton of E5 (E). A similar magnitude of performance improvement is observed from E to F; however, ten times the amount of E5 was used to achieve the performance in F.

E5 without depressant X (G) provided better selectivity than depressant X without E5 (B) under these conditions. It appeared that sequestering chelating agents, such as E3, E4, E5, and E6, have a synergistic effect with depressants, such as depressant X.

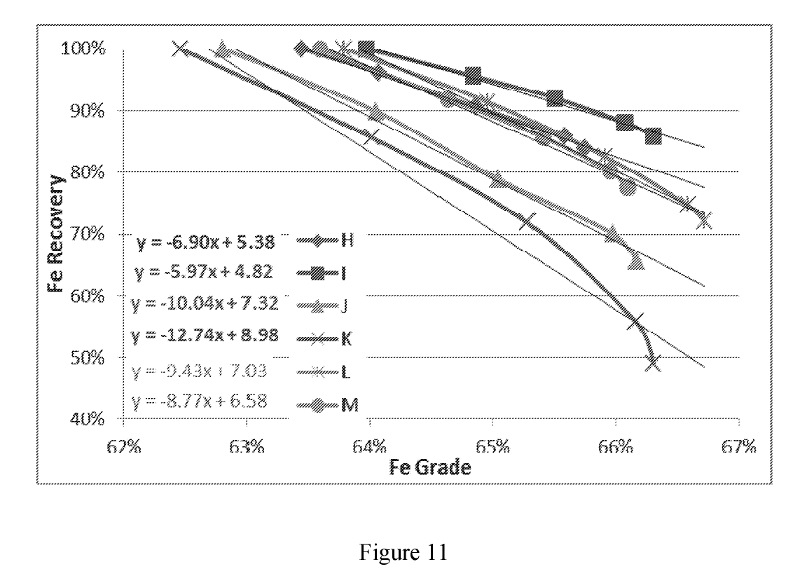

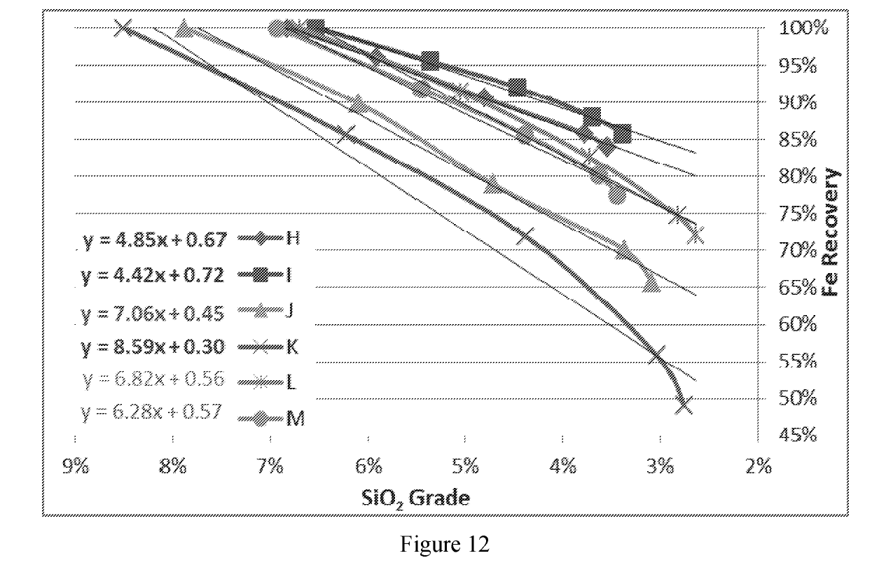

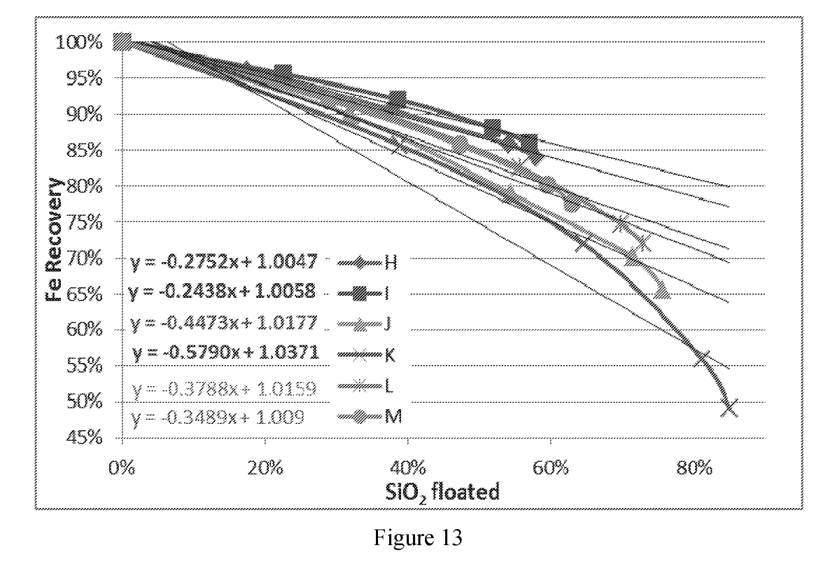

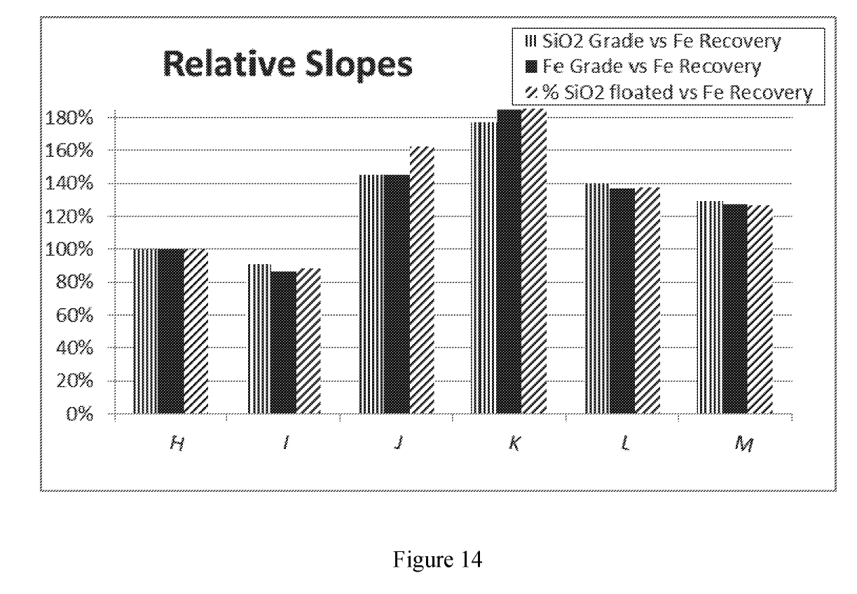

In experiments H-M, a second set of flotation tests were performed, using the same methodology as for experiments A-G, except that the pH was maintained at pH 7.5-8.5. The results are presented in Table 7 and FIGS. 11-14.

TABLE 7
Flotation conditions and results for experiments H-M.

| | | Chel. Agent/ | | | | | | | | | |
|---|---|---|---|---|---|---|---|---|---|---|---|
| | X | Comp. Cpd. | | | Fe | % Depression | | | Relative slope | | |
| ID | (g/ton) | Type | (g/ton) | pH | Recovery | Fe2O3 | SiO2 | SI | SiO₂ ^{a} | Fe ^{a} | SiO₂ ^{b} |
| H | — | — | — | 7.62 | 83.9% | 0.0% | 0.0% | 2.68 | 100% | 100% | 100% |
| I | 2,000 | — | — | 8.51 | 85.8% | 12.0% | 1.64% | 2.83 | 91.1% | 86.5% | 88.6% |
| J | — | C3 | 100 | 7.22 | 65.6% | −113% | −30.5% | 2.44 | 146% | 146% | 163% |
| K | — | E5 | 100 | 7.46 | 49.0% | −217% | −46.7% | 2.34 | 177% | 185% | 210% |
| L | 1,500 | C3 | 100 | 8.57 | 72.0% | −74.0% | −25.7% | 2.63 | 141% | 137% | 138% |
| M | 1,500 | E5 | 100 | 8.49 | 77.5% | −39.8% | −8.50% | 2.42 | 130% | 127% | 127% |

^{a} % Grade vs % Fe Recovery;
^{b} % Floated vs % Fe Recovery.

Experiment I (baseline) showed improvement over the blank (G). Like results at pH 10.5, this appears to be due to the depression of Fe₂O₃ by depressant X. Unlike at pH 10.5, the use of either C3 (J) or E5 (K) without depressant X resulted in a decrease in selectivity. In experiments L and M, depressant X appeared to mitigate some of the negative effects of the additives, but selectivity remained worse than the blank and baseline. This shows that these types of chelating agents are effective at flotation pH values above 9, but not below 9.

### Example 5. Particle Size Analysis with Exemplary Chelating Agents and Comparative Compounds

In this example, particle size was studied by Focused Beam Reflective Measurement (FBRM) experiments to better understand the effect of calcium on flotation.

FBRM experiments were performed on 300 g slurries with 5% solids in DI water. Pure hematite and quartz were obtained from Sigma-Aldrich as: iron(III) oxide powder, <5 μm, ≧99%, BET Surface Area: 5.7425 m²/g; and silicon dioxide, ˜99%, 0.5-10 μm (approximately 80% between 1-5 μm), BET Surface Area: 5.8206 m²/g.

Titrations were performed on the slurries (300 g) with stirring (456 rpm) and pH was maintained at 10.50±0.02 by NaOH (1.0 M and 0.10 M) addition. Titrations were monitored by FBRM particle size analysis. The initial particle size was recorded and CaCl₂ (5 mL, 0.100 M Ca, 0.500 mmol Ca) was added. The agglomeration of SiO₂ was observed. Aliquots of titrant solution were added to bring the particle size of SiO₂ back to the initial value. The CaCl₂(aq) (0.100 M) solution was prepared by dissolving CaCl₂.2H₂O (1.4701 g) in a 100 mL volumetric flask with DI water (calculated: 4,008 mg Ca/L). Titrant solutions were prepared by dissolving 2.50 g of titrant in 50 mL volumetric flasks. Titrants analyzed included: E1, E5, E6, and C3.

The study of particle size dependence on pH in the presence of Ca was performed on SiO₂ as well as Fe₂O₃ (5%) slurries (300 g) with stirring (456 rpm). CaCl₂ (5 mL, 0.10 M Ca, 0.50 mmol Ca) was added and the initial particle size and pH were recorded. Small aliquots of NaOH (0.1 and 1 M) were added recording particle size and pH up to a pH value of 11 to 12. The delta particle size (particle size recorded/initial particle size) is plotted versus pH.

Results and Discussion

FIG. 6 shows the effect of pH on the particle size of SiO₂ and Fe₂O₃. In the presence of Ca (0.5 mmol), SiO₂ will agglomerate above pH 9. At pH 10.5, there is about a 50% increase in the average particle size. The Fe₂O₃ remains unaffected by the presence of Ca ion. In the absence of Ca, SiO₂ does not agglomerate in this way. Therefore, the SiO₂ agglomeration is due to both Ca and elevated pH.

Titration experiments monitoring SiO₂ particle size by FBRM were also carried out. SiO₂ particles were agglomerated at pH 10.5 by Ca (0.500 mmol). Exemplary or comparative chelating agents were added until the particle size distribution returned to initial values or no further particle size reduction occurred. The titration curves are shown in FIG. 16 along.

In the preceding procedures, various steps have been described. It will, however, be evident that various modifications and changes may be made thereto, and additional procedures may be implemented, without departing from the broader scope of the exemplary procedures as set forth in the claims that follow.

We claim:

1. A process for enriching a desired mineral from an ore comprising the desired mineral and gangue, wherein the process comprises: carrying out a flotation process on the ore in the presence of one or more chelating agents, one or more collecting agents, one or more types of multivalent metal ions, and optionally one or more depressants, in a solution;
wherein the one or more chelating agents are capable, alone or as a group of compounds, of sequestering a multivalent metal or multivalent metal ion in the form of a metal-chelating agent complex that remains at least partially soluble in the solution.

2. The process of claim 1, wherein the process comprises carrying out a flotation process on the ore in the presence of one or more chelating agents, one or more collecting agents, one or more types of multivalent metal ions, and one or more depressants, in a solution.

3. A process for the selective flotation of a desired mineral from an ore comprising the desired mineral and gangue, wherein the process comprises: (a) forming a flotation pulp by grinding ore comprising a desired mineral and gangue in an aqueous fluid, wherein the flotation pulp comprises one or more types of dissolved multivalent metal ions; (b) adding one or more chelating agents, one or more collecting agents, and optionally one or more depressants, to the flotation pulp; (c) subjecting the flotation pulp to flotation to form a flotation float product comprising the gangue and a flotation non-float product comprising the desired mineral; wherein the one or more chelating agents are capable, alone or as a group of compounds, of sequestering a multivalent metal or multivalent metal ion in the form of a metal-chelating agent complex that remains at least partially soluble in the flotation pulp.

4. The process of claim 3, wherein the process comprises adding one or more chelating agents, one or more collecting agents, and one or more depressants, to the flotation pulp.

5. The process of claim 3, further comprising step (d) separating the flotation float product from the flotation non-float product.

6. The process of claim 1, wherein at least one of the one or more depressants comprises one or more types of polysaccharides comprising one or more types of pentosan units.

7. The process of claim 1, wherein at least one of the one or more depressants comprises one or more types of polysaccharides is starch or modified starch.

8. The process of claim 1, wherein the desired mineral is an iron-containing mineral.

9. The process of claim 1, wherein the gangue comprises quartz, oxides of silica, silicates or siliceous materials.

10. The process of claim 1, wherein the flotation process is a reverse cationic flotation process.

11. The process of claim 1, wherein the flotation process is a reverse anionic flotation process.

12. The process of claim 6, wherein the one or more types of pentosan units comprise xylan units.

13. The process of claim 1, wherein the one or more chelating agents are selected from the group consisting of: ethylenediaminetetraacetic acid (EDTA), and salts and/or hydrates thereof; citric acid, and salts and/or hydrates thereof; one or more chelating agents are selected from polymers comprising one or more sulfonic acid- or carboxylic acid-containing monomers; and salts thereof.

14. The process of claim 1, wherein the one or more collecting agents comprises an ether diamine or ether monoamine.

15. The process of claim 1, wherein the one or more types of multivalent metal ions comprise calcium, magnesium, or iron.

16. The process of claim 15, wherein the multivalent ions are present in the flotation pulp at a concentration of about 1 to about 2500 ppm.

17. The process of claim 1, wherein the one or more frothing agents are added to the flotation pulp.

18. The process of claim 1, wherein the flotation process is carried out at a pH in the range of about 9 to about 13.

19. The process of claim 3, wherein the one or more chelating agents are selected from the group consisting of: ethylenediaminetetraacetic acid (EDTA), and salts and/or hydrates thereof; citric acid, and salts and/or hydrates thereof; one or more chelating agents are selected from polymers comprising one or more sulfonic acid- or carboxylic acid-containing monomers; and salts thereof.

20. The process of claim 3, wherein the one or more types of multivalent metal ions comprise calcium, magnesium, or iron.
